(19) United States
(12) Patent Application Publication
(10) Pub. No.: US 2025/0133206 A1
(43) Pub. Date: Apr. 24, 2025

(54) METHOD AND APPARATUS FOR VIDEO ENCODING AND DECODING, AND METHOD FOR TRANSMITTING A BITSTREAM GENERATED BY THE VIDEO ENCODING METHOD

(71) Applicant: RESEARCH & BUSINESS FOUNDATION SUNGKYUNKWAN UNIVERSITY, Suwon-si (KR)

(72) Inventors: Eun Seok RYU, Seoul (KR); Jong Beom JEONG, Seoul (KR); Jun Hyeong PARK, Seoul (KR)

(73) Assignee: RESEARCH & BUSINESS FOUNDATION SUNGKYUNKWAN UNIVERSITY, Suwon-si (KR)

(21) Appl. No.: 18/786,195

(22) Filed: Jul. 26, 2024

(30) Foreign Application Priority Data
Oct. 24, 2023 (KR) 10-2023-0142819

(51) Int. Cl. H04N 19/119; H04N 19/115; H04N 19/162; H04N 19/172

(52) U.S. Cl. CPC H04N 19/119; H04N 19/115; H04N 19/162; H04N 19/172

(57) ABSTRACT

An image encoding/decoding method and apparatus and a method for transmitting a bitstream generated by the image encoding method are provided. The image encoding method according to the present disclosure may include: encoding an image in sub-regions with different sizes and generating one or more bitstreams for the sub-regions; obtaining a user viewport for the image; allocating sub-regions corresponding to the user viewport among the sub-regions to the image, wherein the image includes an inner region located inside the user viewport, a boundary region adjacent to a boundary of the user viewport, and an outer region located outside the user viewport; and generating at least one bitstream corresponding to the allocated sub-regions from bitstreams for the sub-regions, and a sub-region with a relatively large size may be allocated within the inner region, and a sub-region with a relatively small size may be allocated within the boundary region.

### CROSS REFERENCE TO RELATED APPLICATION

The present application claims priority to a KR application 10-2023-0142819, filed Oct. 24, 2023, the entire contents of which are incorporated herein for all purposes by this reference.

### BACKGROUND OF THE INVENTION

### Field of the Invention

The present disclosure relates to a method for encoding and decoding an image, and more particularly, to a method and apparatus for image encoding/decoding that partition an image into tiles with different sizes, and a method for transmitting a bitstream generated by the image encoding method.

### Description of the Related Art

With the recent advances in virtual reality technology and equipment, devices for experiencing virtual reality such as head-mounted display (HMD) are being released.

As an HMD should reproduce an omnidirectional 360-degree image, an ultra high-definition (UHD) and above image is required, and a high bandwidth is demanded for transmitting the image accordingly.

In order to meet the demand for such a high bandwidth, there has been proposed a method of specifying, for a single image, a region watched by a user (a user viewport or a user's region of interest) in a rectangular tile and transmitting the tile in high definition and transmitting the remaining tiles in low definition.

Generally, when a lot of small-sized tiles are generated, a user viewport may be precisely searched and a bit rate may be allocated accordingly, thereby enhancing efficiency, while as many decoders as corresponding to the number of tiles should be provided, which may cause a problem in implementing synchronization of decoded pictures.

Thus, a technique is required to adaptively select tiles with various sizes according to a user viewport, to adaptively allocate bit rates to the tiles and to merge the tiles.

### SUMMARY

The present disclosure is directed to providing a method and apparatus for image encoding/decoding and a transmission method.

In addition, the present disclosure is directed to providing a method for adaptively allocating tiles with various sizes according to a user viewport.

In addition, the present disclosure is directed to providing a method for adaptively determining bit rates of tiles that are allocated according to a user viewport.

In addition, the present disclosure is directed to providing a method for transmitting a bitstream that is generated by an image encoding method or apparatus according to the present disclosure.

In addition, the present disclosure is directed to providing a recording medium for storing a bitstream that is generated by an image encoding method or apparatus.

In addition, the present disclosure is directed to providing a recording medium for storing a bitstream that is received and decoded by an image decoding apparatus and is used to reconstruct an image.

The technical problems solved by the present disclosure are not limited to the above technical problems and other technical problems which are not described herein will be clearly understood by a person having ordinary skill in the technical field, to which the present disclosure belongs, from the following description.

According to an aspect of the present disclosure, an image encoding method performed by an image encoding apparatus may include: encoding an image in sub-regions with different sizes and generating one or more bitstreams for the sub-regions; obtaining a user viewport for the image; allocating sub-regions corresponding to the user viewport among the sub-regions to the image, wherein the image includes an inner region located inside the user viewport, a boundary region adjacent to a boundary of the user viewport, and an outer region located outside the user viewport; and generating at least one bitstream corresponding to the allocated sub-regions from bitstreams for the sub-regions, and a sub-region with a relatively large size may be allocated within the inner region, and a sub-region with a relatively small size may be allocated within the boundary region.

According to an aspect of the present disclosure, an image encoding apparatus may include: a memory; and at least one processor, the at least one processor may be configured to encode an image in sub-regions with different sizes and generate one or more bitstreams for the sub-regions, to obtain a user viewport for the image, to allocate sub-regions corresponding to the user viewport among the sub-regions to the image, wherein the image includes an inner region located inside the user viewport, a boundary region adjacent to a boundary of the user viewport, and an outer region located outside the user viewport, and to generate at least one bitstream corresponding to the allocated sub-regions from bitstreams for the sub-regions, a sub-region with a relatively large size may be allocated within the inner region, and a sub-region with a relatively small size may be allocated within the boundary region.

According to an aspect of the present disclosure, in a method for transmitting a bitstream generated by an image encoding method, the image encoding method may include: encoding an image in sub-regions with different sizes and generating one or more bitstreams for the sub-regions; obtaining a user viewport for the image; allocating sub-regions corresponding to the user viewport among the sub-regions to the image, wherein the image includes an inner region located inside the user viewport, a boundary region adjacent to a boundary of the user viewport, and an outer region located outside the user viewport; and generating at least one bitstream corresponding to the allocated sub-regions from bitstreams for the sub-regions, and a sub-region with a relatively large size may be allocated within the inner region, and a sub-region with a relatively small size may be allocated within the boundary region.

The features briefly summarized above with respect to the present disclosure are merely exemplary aspects of the detailed description of the present disclosure that follows, and do not limit the scope of the present disclosure.

According to the present disclosure, a bit rate and a decoding time may be reduced as compared with using a tile with a single size.

In addition, according to the present disclosure, because a tile bitstream is selected to be compatible with a motion-constrained tile set (MCTS) and an extractable subpicture (ES) in image compression standards like High-Efficiency Video Coding (HEVC) and Versatile Video Coding (VVC), both merging into a single bitstream and transmission thereof and transmission of individual bitstreams are implementable so that compatibility and versatility of implementation may be secured.

The effects obtainable from the present disclosure are not limited to the above-mentioned effects, and other effects not mentioned herein will be clearly understood by those skilled in the art through the following descriptions.

### BRIEF DESCRIPTION OF THE DRAWINGS

FIG. 1 is a view showing the concept of a multi-view image in an immersive image according to an embodiment of the present disclosure.

FIG. 2A and FIG. 2B are views schematically showing a test model for immersive video (TMIV) encoder apparatus and a TMIV decoder apparatus according to an embodiment of the present disclosure.

FIG. 3A is a view schematically showing a pipeline of an immersive image encoding apparatus to which embodiments of the present disclosure are applicable.

FIG. 3B is a view schematically showing a pipeline of an immersive image decoding apparatus to which embodiments of the present disclosure are applicable.

FIG. 4 is a view schematically showing an image encoding apparatus and an image decoding apparatus to which embodiments of the present disclosure are applicable.

FIG. 5 is a flowchart showing an image encoding method according to an embodiment of the present disclosure.

FIG. 6 is a view showing an example of tiles that are allocated according to an embodiment of the present disclosure.

FIG. 7 is a flowchart showing an image encoding method according to another embodiment of the present disclosure.

FIG. 8 is a view showing an example of tiles that are allocated according to another embodiment of the present disclosure.

FIG. 9 is a flowchart showing an image encoding method according to yet another embodiment of the present disclosure.

FIG. 10 is a view showing an example of tiles that are allocated according to yet another embodiment of the present disclosure.

FIG. 11 is a flowchart showing an image encoding method according to yet another embodiment of the present disclosure.

FIG. 12 is a view exemplifying a method for allocating a bit rate according to yet another embodiment of the present disclosure.

### DETAILED DESCRIPTION OF THE INVENTION

Hereinafter, embodiments of the present disclosure will be described in detail with reference to the accompanying drawings, which will be easily implemented by those skilled in the art. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. In addition, parts not related to the description of the present disclosure in the drawings are omitted, and like parts are denoted by similar reference numerals.

In the present disclosure, when a component is said to be “connected”, “coupled” or “linked” with another component, this may include not only a direct connection, but also an indirect connection in which another component exists in the middle therebetween. In addition, when a component “includes” or “has” other components, it means that other components may be further included rather than excluding other components unless the context clearly indicates otherwise.

In the present disclosure, terms such as first and second are used only for the purpose of distinguishing one component from other components, and do not limit the order, importance, or the like of components unless otherwise noted. Accordingly, within the scope of the present disclosure, a first component in an embodiment may be referred to as a second component in another embodiment, and similarly, a second component in an embodiment may also be referred to as a first component in another embodiment.

In the present disclosure, components that are distinguished from each other are intended to clearly describe each of their characteristics, and do not necessarily mean that the components are separated from each other. That is, a plurality of components may be integrated into one hardware or software unit, or one component may be distributed to be configured in a plurality of hardware or software units. Therefore, even when not stated otherwise, such integrated or distributed embodiments are also included in the scope of the present disclosure.

In the present disclosure, components described in various embodiments do not necessarily mean essential components, and some may be optional components. Accordingly, an embodiment consisting of a subset of components described in an embodiment is also included in the scope of the present disclosure. In addition, embodiments including other components in addition to the components described in the various embodiments are included in the scope of the present disclosure.

In the present disclosure, “/” and “,” may be interpreted as “and/or”. For example, “A/B” and “A, B” may be interpreted as “A and/or B”. In addition, “A/B/C” and “A, B, C” may mean “at least one of A, B and/or C”.

In the present disclosure, “or” may be interpreted as “and/or”. For example, “A or B” may mean 1) only “A”, 2) only “B”, or 3) “A and B”. Alternatively, in the present disclosure, “or” may mean “additionally or alternatively”.

In the present disclosure, the terms “image”, “video”, “immersive image” and “immersive video” may be used interchangeably.

Hereinafter, embodiments of the present disclosure will be described in detail with reference to the accompanying drawings. In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

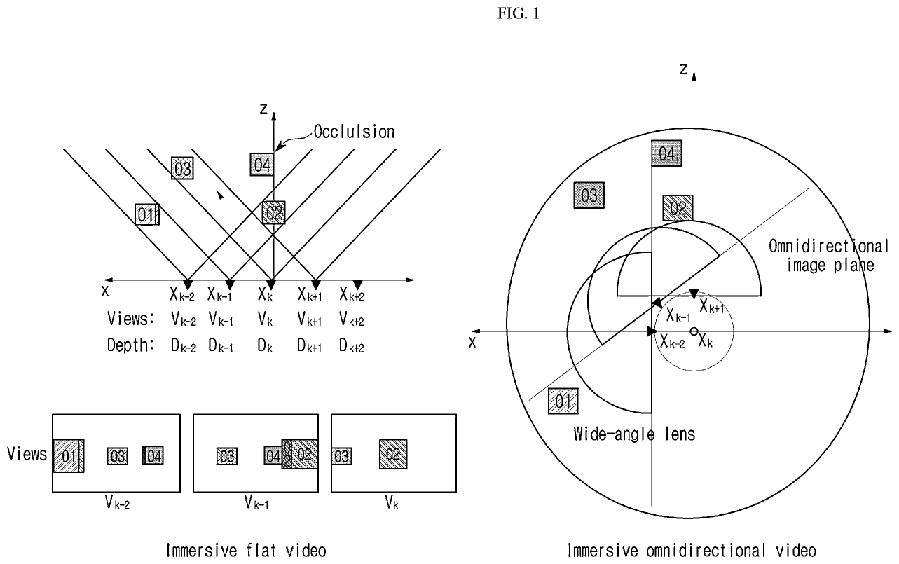

FIG. 1 is a view showing the concept of a multi-view image in an immersive image according to an embodiment of the present disclosure.

Referring to FIGS. 1, 01 to 04 may represent regions of an image in a random scene, Vk may represent an image obtained in a camera center location, Xk may represent a view location (camera location), and Dk may represent depth information in the camera center location.

In an immersive image, an image may be generated in various directions in a plurality of locations to support 6DoF according to a user's movement. An immersive image may consist of omnidirectional image-related space information (depth information and camera information). An immersive image may be transmitted to a terminal side through image compression, packet multiplexing process and the like.

An immersive image system may obtain, generate, transmit and reproduce a large-capacity immersive image that consists of multiple views. Accordingly, an immersive image system should effectively store and compress a large amount of image data and be compatible with an existing immersive image (3DoF).

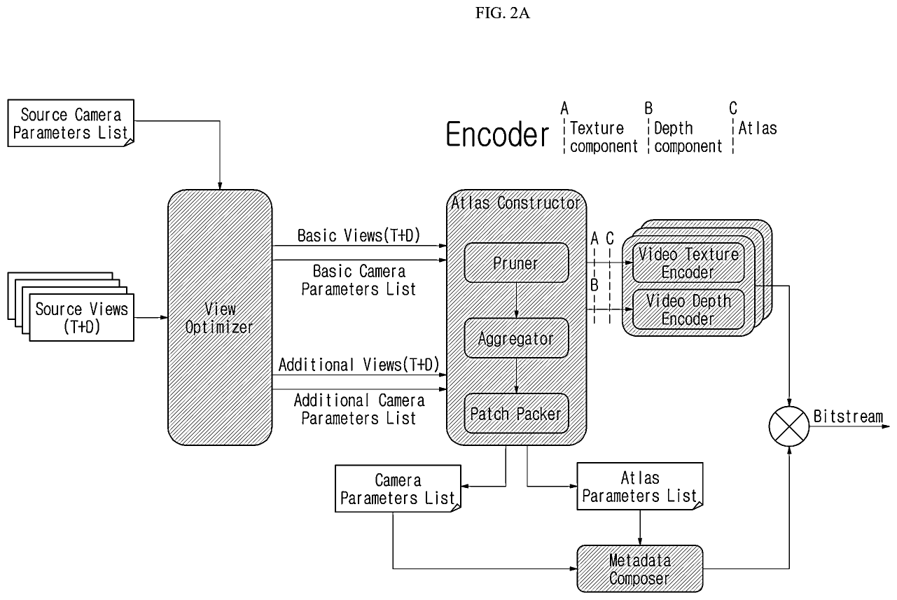

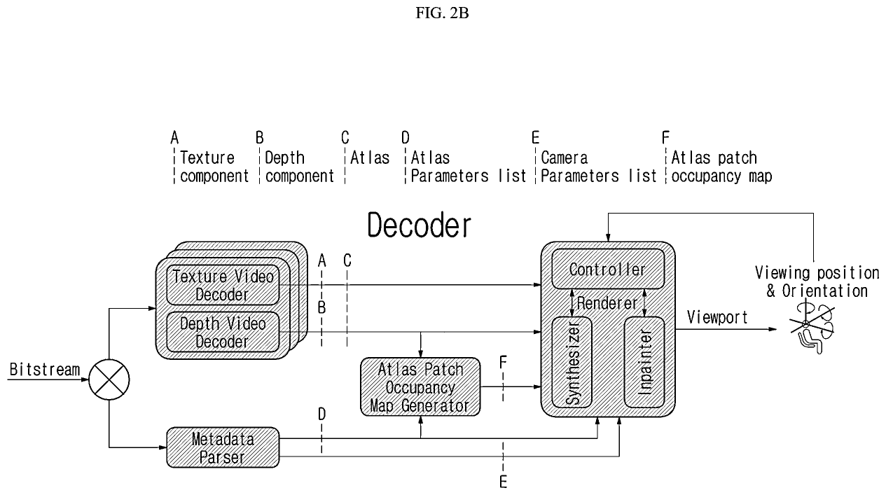

FIG. 2A and FIG. 2B are views schematically showing a test model for immersive video (TMIV) encoder apparatus and a TMIV decoder apparatus according to an embodiment of the present disclosure. Herein, the TMIV encoder may be an immersive image encoding apparatus, and the TMIV decoder may be an immersive image decoding apparatus.

Referring to FIG. 2A, an input of the TMIV encoder may be encoded sequentially through a view optimizer, an atlas constructor, a video texture encoder, and a video depth encoder.

In a view optimizing process, a required number of basic views may be determined in consideration of a directional difference, a field of view (FoV), a distance, and an overlap between FoVs. Next, in the view optimizing process, a basic view may be selected in consideration of a relative location between views and an overlap of views.

A pruner of the atlas constructor may preserve basic views by using a mask and remove an overlapping portion of additional views. An aggregator may update a mask used in a video frame in chronological order.

Next, a patch packer may generate an ultimate atlas by packing respective patch atlases. An atlas of a basic view may be constructed with the same texture and depth information as that of an original. An atlas of an additional view may be constructed with texture and depth information in a block patch form.

Referring to FIG. 2B, the TMIV decoder may reconstruct a basic view and an atlas regarding video texture and depth information. In addition, a reconstructed output may be finally generated through an atlas patch occupancy map generator and a renderer.

Specifically, the TMIV decoder may obtain a bitstream. In addition, a texture and a depth may be transmitted to the renderer through a texture video decoder and a depth video decoder. The renderer may consist of three steps of controller, synthesizer and inpainter.

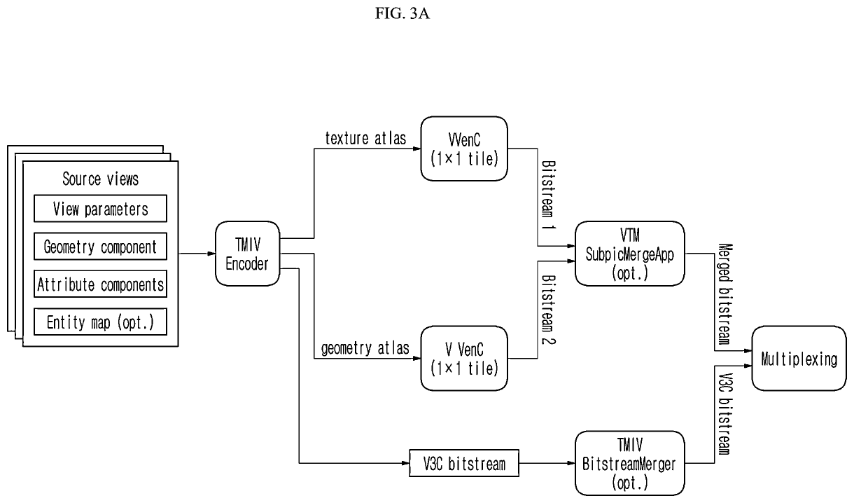

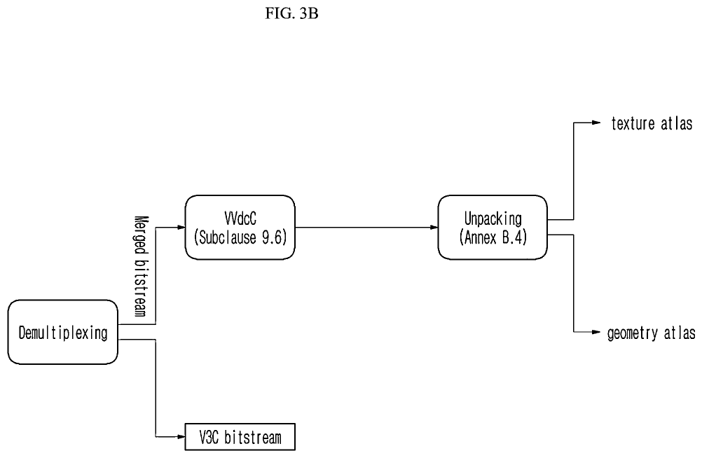

FIG. 3A is a view schematically showing a pipeline of an immersive video encoding apparatus to which embodiments of the present disclosure are applicable, and FIG. 3B is a view schematically showing a pipeline of an immersive video decoding apparatus to which embodiments of the present disclosure are applicable.

Referring to FIG. 3B, by a TMIV encoder, a texture atlas and geometry atlases may be obtained from source views. The geometry atlases may be obtained through a method of partitioning a geometry atlas (first geometry atlas) that is extracted from source views by the TMIV encoder. In addition, geometry atlases thus partitioned may be obtained in a state of being packed in a specific direction.

A texture atlas may be encoded by an encoder located on an upper side (versatile video encoder (VVenC)), and thus Bitstream 1 corresponding to a texture bitstream may be generated. As an example, the texture atlas may be encoded in a 1×1 tile or 1×1 subpicture and thus be generated as Bitstream 1. A texture bitstream may be a texture atlas bitstream.

Geometry atlases (packed geometry atlases) may be encoded by an encoder located on a lower side (versatile video encoder (VVenC)), and thus Bitstream 2 corresponding to a geometry bitstream may be generated. As an example, the packed geometry atlases may also be encoded in a 1×1 tile or 1×1 subpicture and thus be generated as Bitstream 2. A geometry bitstream may be a geometry atlas bitstream.

FIG. 3A discloses an example of encoders implemented as VvenCs, but the encoders may be implemented as encoders based on High-Efficiency Video Coding (HEVC), AOMedia Video 1 (AVI) and the like.

Bitstream 1 and Bitstream 2 may be input into a synthesizer (VTM (VVC Test Model) SubpicMergeApp) to be merged, and a merged bitstream may be generated as a result. SubpicMergeApp may correspond to a subconfiguration that supports a subpicture merge function in a VTM. Bitstream 1 and Bitstream 2 may be synthesized in various locations. For example, Bitstream 2 (geometry bitstream) may be merged to be located on the right-hand side of Bitstream 1 (texture bitstream).

When bitstreams are merged, since a texture atlas and a geometry atlas are located in a single tile or picture, a V3C bitstream including atlas and packing information needs to be modified. To this end, packing information is modified suitably for a tile or picture in a ‘merged bitstream’, and a modified V3C bitstream may be generated.

The merged bitstream and the modified V3C bitstream may be multiplexed to be combined into one bitstream.

Referring to FIG. 3B, the combined bitstream may be demultiplexed to be output into a merged bitstream and a V3C bitstream. The merged bitstream may be output into a texture atlas and a geometry atlas through a decoding process (versatile video decoder (VVdeC)) and an unpacking process.

FIG. 3B discloses an example of a decoder implemented as VvenC, but the decoder may be implemented as a decoder based on High-Efficiency Video Coding (HEVC), AOMedia Video 1 (AVI) and the like.

### Problem of the Related Art

In case a 360-degree image is transmitted, a region, which is actually seen to a user through an HMD, is a part of the image. Accordingly, if user viewport information is identifiable beforehand, the overall region of the image does not need to be transmitted but only a partial region corresponding to the user viewport may be transmitted.

For this reason, an MCTS technology has been proposed to extract only a partial region from an overall image in a rectangular tile, and a technique for selecting and extracting a tile corresponding to a user viewport has also been proposed.

Through an early study on tile streaming, efficiency of bit rates is measured by adjusting the size of a tile, and it is demonstrated that the smaller the size of a tile, the more precisely the user viewport is searched and thus bit rates can be efficiently allocated.

However, when the number of tiles increases, the number of slices belonging to a network abstraction layer, which is a constituent element of a bitstream, also increases and overhead of bit rates occurs, which may result in decreasing efficiency of bit rates. In addition, when an individual bitstream is constructed for each tile, a plurality of decoded pictures should be processed in a system, which may result in increasing difficulty of implementation.

To solve this problem, there is an attempt to select an adaptive tile to a user viewport by using a plurality of tile sizes. However, this study does not sufficiently consider MCTS and fails to secure versatility of decoding because of construction of individual tile bitstreams.

MPEG (Moving Picture Experts Group), which is an international image compression standardization group, developed the VDI (Video Decoding Interfaces) standard to solve the problem. Specifically, VDI defines a technology that can construct a single bitstream through extraction and merging of bitstreams and handle a plurality of decoding picture buffers. However, despite such an attempt, no method has been proposed which can be applied to immersive images like 360-degree images, save bit rates and also solve the problem of the decoder side.

### EMBODIMENTS

To solve the above-mentioned problems, the present disclosure proposes various embodiments that are described below. Embodiments of the present disclosure are applicable to various image compression technologies such as HEVC and VVC and to 6DoF immersive image transmission, decoding and rendering.

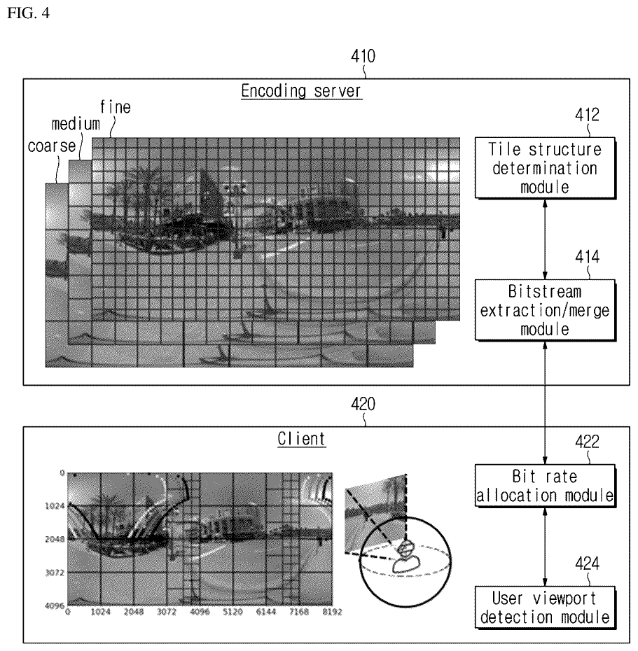

FIG. 4 is a view schematically showing a streaming system to which embodiments of the present disclosure are applicable.

Referring to FIG. 4, the streaming system may be configured to include an image encoding apparatus (encoding server) 410 and an image decoding apparatus (client) 420. The image encoding apparatus 410 may be configured to include a tile structure determination module 412 and a bitstream extraction/merge module 414. The image decoding apparatus 420 may be configured to include a bit rate allocation module 422 and a user viewport detection module 424.

As exemplified in FIG. 4, the image encoding apparatus 410 may generate a bitstream by encoding an image (for example, an immersive 360-degree image) in sub-regions with various sizes. A sub-region may be a sub-unit constituting a picture such as a tile, a slice, and a subpicture. Hereinafter, the sub-region will be referred to as “tile”. Tiles may be classified into a large-sized (coarse) tile with a relatively large size, a medium-sized (medium) tile with a relatively medium size, and a small-sized (fine) tile with a relatively small size. However, this classification is merely one example, and tiles may be classified into 2 types or 4 or more types depending on relative sizes. The large-sized tile may be referred to as “first size tile”, the small-sized tile may be referred to as “third size tile”, and the medium-sized tile may be referred to as “second size tile”.

The tile structure determination module 412 may detect a user viewport in an image based on user viewport information that is transmitted from the user viewport detection module 424 of the image decoding apparatus 420. In addition, the tile structure determination module 412 may allocate tiles to an image based on the user viewport. Sizes of tiles, which are allocated based on a user viewport, may be determined according to a relative location relationship with the user viewport. For example, a large-sized tile (first size tile) may be allocated closer to a center part of a user viewport, and a small-sized tile (third size tile) may be allocated closer to a boundary part of the user viewport. Herein, the center part of the user viewport may be referred to as “inner region”, and the boundary part of the user viewport may be referred to as “boundary region”. In addition, in an image, a region excluding an inner region and a boundary region, that is, a region located outside a user viewport may be referred to as “outer region”.

The bitstream extraction/merge module 414 may extract an individual tile bitstream by encoding an image, to which tiles are allocated, and allocate a bit rate for the image based on a tile structure determined by the tile structure determination module 412 and a bit rate per tile that is transmitted from the bit rate allocation module 422. A relatively high bit rate may be allocated inside a user viewport (inner region and boundary region), and a relatively low bit rate may be allocated outside the user viewport (outer region). According to embodiments, the bitstream extraction/merge module 414 may merge individual tile bitstreams. Allocation of bit rates may be performed for a tile inside a user viewport (inner region and boundary region) and/or a tile outside the user viewport (outer region).

The image decoding apparatus 420 may transmit user viewport information detected by the user viewport detection module 424 to the image encoding apparatus 410 and calculate a target bit rate through the bit rate allocation module 422 and transmit the target bit rate to the image encoding apparatus 410. In addition, the image decoding apparatus 420 may decode a bitstream transmitted from the image encoding apparatus 410, render a user viewport to a decoded result and display it.

The bit rate allocation module 422 may calculate a target bit rate that is adaptive to the image decoding apparatus 410 and a network environment, and the user viewport detection module 424 may detect information on a viewport where a user sees.

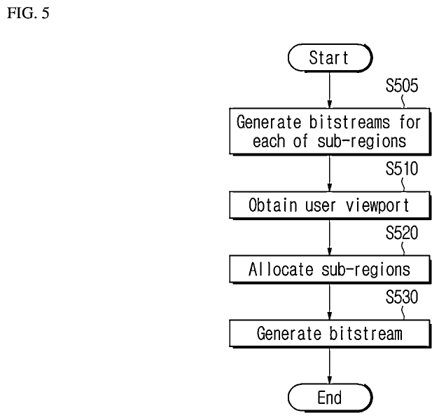

FIG. 5 is a flowchart showing an image encoding method according to an embodiment of the present disclosure. Each step of FIG. 5 may be performed by the image encoding apparatus 410.

Referring to FIG. 5, an image may be encoded in tiles with different sizes and one or more bitstreams may be generated for the tiles (S505). For example, a bitstream may be generated by encoding the image in a large-sized tile, a bitstream may be generated by encoding the image in a medium-sized tile, and a bitstream may be generated by encoding the image in a small-sized tile.

A user viewport for the image may be obtained (S510). User viewport information may be detected by the user viewport detection module 424 and be transmitted through the image decoding apparatus 420. The user viewport may be derived based on the user viewport information.

Among the tiles with different sizes, tiles corresponding to the user viewport may be allocated to the image (S520). For example, a large-sized tile (first size tile) may be allocated to an inner region of the image, and a small-sized tile (third size tile) may be allocated to a boundary region of the image. According to embodiments, tiles belonging to a same row may be allocated to have a same size. Through this constraint, tiles may be encoded in row units, and a single bitstream may be generated.

From bitstreams for tiles with different sizes, at least one bitstream corresponding to the allocated tiles may be generated (S530). For example, from the bitstreams for the tiles with different sizes, the allocated tiles may be extracted and merged, so that an ultimate bitstream may be generated. Bitstreams may be generated according to each tile, or one bitstreams may be generated by merging the bitstreams. The number of bitstreams may be determined based on the number of the image decoding apparatus 420 (specifically, the number of decoding modules in the image decoding apparatus).

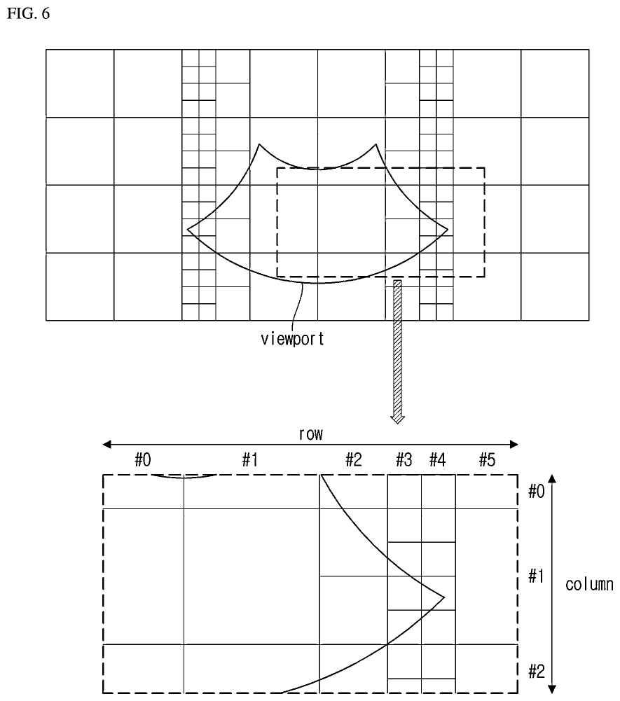

FIG. 6 is a view showing an example of tiles that are allocated according to an embodiment of the present disclosure. In FIG. 6, a largest rectangle represents a large-sized file, a medium-sized rectangle represents a medium-sized tile, and a smallest rectangle represents a small-sized tile.

Adaptive tile structure determination according to a user viewport may be performed in an intra-period unit. For example, an intra-period may be set to 32 frames. However, this is merely an example, and an intra-period may be set to a value less than 32 frames or be set to a value exceeding 32 frames.

As exemplified in FIG. 6, a region inside a user viewport (inner region) may consist of large-sized tiles, and a user viewport boundary region (boundary region) may consist of medium-sized or small-sized tiles. In addition, a region outside a user viewport (outer region) may consist of large-sized tiles.

A plurality of small tiles in one tile may be considered as slices and be included vertically. That is, medium-sized tiles and small-sized tiles may each be considered as 2 or 4 slices that are vertically aligned, and thus a single tile may be constructed. For example, as 2 medium-sized tiles located in the column #1 and the row #2 have a same width as that of a medium-sized tile and a same height as that of a large-sized tile, the 2 medium-sized tiles may be considered as medium-sized slices, be vertically aligned and be expressed as a single tile. As another example, as 4 small-sized tiles located in the column #1 and the row #3 have a same width as that of a small-sized tile and a same height as that of a large-sized tile, the 4 small-sized tiles may be considered as small-sized slices, be vertically aligned and be expressed as a single tile.

A relatively high bit rate may be allocated to a tile inside a user viewport (inner region and boundary region), and a relatively low bit rate may be allocated to a tile outside the user viewport (outer region). Through such allocation of bit rates, a high-quality user viewport may be provided, while bit rates are reduced. However, this is merely one example, and a bit rate may be adaptively allocated according to a distance between a center of a user viewport and a tile.

### Embodiment 1

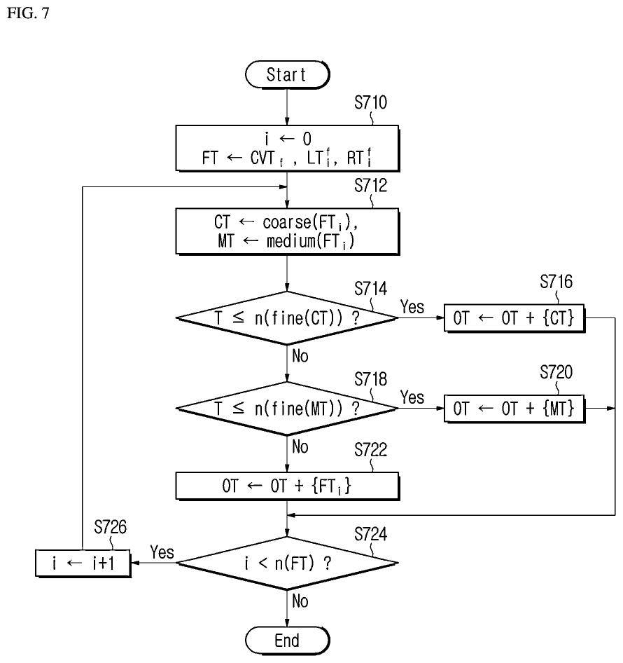

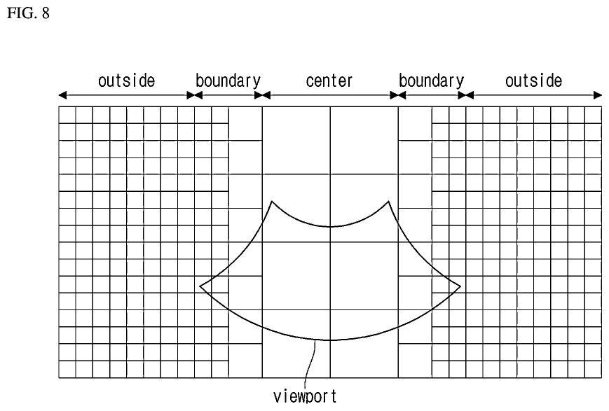

Embodiment 1 relates to a method for adaptively allocating tiles to an inner region and a boundary region. An image encoding method according to Embodiment 1 is shown in FIG. 7, and an example of allocating tiles according to Embodiment 1 is shown in FIG. 8.

In FIG. 7, CVT_{f} represents a small-sized tile located at the center of a user viewport and tiles located at a same row, LTᵢ^{f} represents small-sized tiles located on the left-hand side of the user viewport (center+boundary), and RTᵢ^{f} represents small-sized tiles located on the right-hand side of the user viewport (center+boundary). T represents a tile occupancy threshold value (predetermined threshold value) for determining an adaptive user viewport tile, and OT represents a set of optimal adaptive user viewport tiles. coarse (Tᵢ) is a function that returns a large-sized tile including a small-sized tile Tᵢ, medium (Tᵢ) is a function that returns a medium-sized tile including a small-sized tile Tᵢ, and fine (Tᵢ) is a function that returns small-sized tiles included in a tile Tᵢ. n(PT) is a function that returns the number of elements included in a set FT.

Referring to FIG. 7 and FIG. 8, the value of i may be initialized to 0, and all the tiles (CVT_{f}, LTᵢ^{f} and Rtᵢ^{f}) may be sequentially put into the set FT (S710). A large-sized tile including a small-sized tile FTᵢ may be put into a variable CT, and a medium-sized tile including a small-sized tile FTᵢ may be put into a variable MT (S712).

A value of n(fine (CT)), which represents the number of small-sized tiles included in the large-sized tile CT, and a value of the threshold T may be compared with each other (S714). In case the value of n(fine (CT)) is equal to or greater than the value of the threshold T, and CT may be included in OT that is a set of optimal tiles (S716). That is, if the condition is step S714 is satisfied, it means that the large-sized tile CT includes a small-sized tile equal to or greater than the threshold value T, and a large-sized tile may be allocated accordingly.

On the other hand, in case the value of n(fine (CT)) is less than the threshold value T, it means that the large-sized tile CT includes a small-sized tile less than the threshold value T, and thus the value of n(fine (MT)) representing the number of small-sized tiles included in the medium-sized tile MT and the threshold value T may be compared with each other (S718). In case the value of n(fine (MT)) is equal to or greater than the value of the threshold T, and MT may be included in OT that is a set of optimal tiles (S720). That is, if the condition is step S718 is satisfied, it means that the medium-sized tile MT includes a small-sized tile equal to or greater than the threshold value T, and a medium-sized tile may be allocated accordingly.

On the other hand, in case the value of n(fine (MT)) is less than the threshold value T, it means that the medium-sized tile MT includes a small-sized tile less than the threshold value T, and thus only FTᵢ, which is a small-sized tile, may be included in OT that is a set of optimal tiles (S722). That is, if the condition of step S718 is not satisfied, small-sized tiles may be allocated.

In order to see whether or not all the elements of the set FT have been checked, the value of i and the value of n(FT) representing the number of elements of the set FT may be compared with each other (S724). In case the value of i is smaller than the value of n(FT), 1 may be added to i (S726) to perform the above-described processes for a next element in the set FT, and in case the value of i is equal to or greater than the value of n(FT), the allocation process may end since all the elements have been checked.

### Embodiment 2

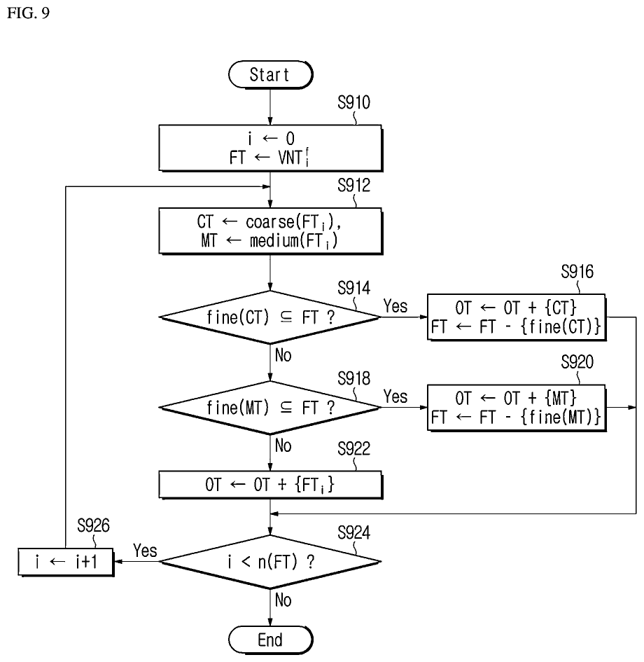

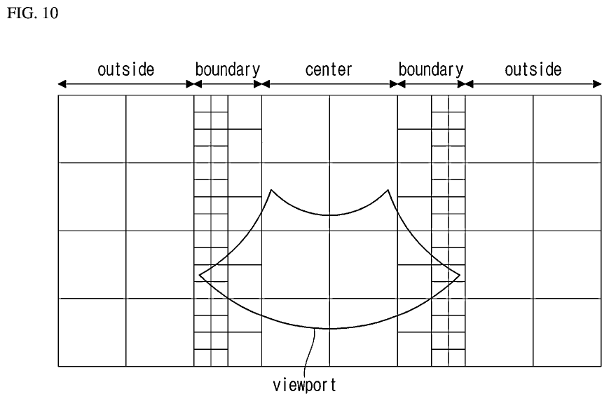

Embodiment 2 relates to a method for adaptively allocating tiles to an outer region. An image encoding method according to Embodiment 2 is shown in FIG. 9, and an example of allocating tiles according to Embodiment 2 is shown in FIG. 10.

In FIG. 9, NVTᵢ^{f} represents a set of tiles (in an outer region) outside a user viewport, and OT represents a set of optimal tiles after Embodiment 1 is performed. coarse (Tᵢ) is a function that returns a large-sized tile including a small-sized tile Tᵢ, medium (Tᵢ) is a function that returns a medium-sized tile including a small-sized tile Tᵢ, and fine (Tᵢ) is a function that returns small-sized tiles included in a tile Tᵢ.

Referring to FIG. 9 and FIG. 10, the value of i may be initialized to 0, and NVTᵢ^{f} may be put into the set FT (S910). A large-sized tile including a small-sized tile FTᵢ may be put into a variable CT, and a medium-sized tile including a small-sized tile FTᵢ may be put into a variable MT (S912).

It may be determined whether or not fine(CT), that is, small-sized tiles included in a large-sized tile CT are included in FT (S914). That is, it may be determined whether or not small-sized tiles included in a large-sized tile are included in an outer region. In case fine(CT) is included in FT, CT is added to OT, which is a set of optimal tiles, and fine(CT) may be removed from FT (S916). That is, if the condition of step S914 is satisfied, it means that CT, which is a large-sized tile, does not overlap with an existing set of optimal tiles, so that the large-sized tile CT may be allocated.

On the other hand, in case fine(CT) is not included in FT, it means that the large-sized tile CT overlaps with the existing set of optimal tiles, and thus whether or not the medium-sized tile MT is included in FT may be determined (S918). That is, it may be determined whether or not small-sized tiles included in a medium-sized tile are included in the outer region. In case fine(MT) is included in FT, MT is added to OT, which is a set of optimal tiles, and fine(MT) may be removed from FT (S920). That is, if the condition of step S918 is satisfied, it means that MT, which is a large-sized tile, does not overlap with the existing set of optimal tiles, so that the medium-sized tile MT may be allocated.

On the other hand, in case fine(MT) is not included in FT (neither fine(CT) nor fine(MT) is included in FT), FTᵢ may be included in OT (S922). That is, in case neither the large-sized tile CT nor the medium-sized tile MT is included in FT, the small-sized tile FTᵢ may be allocated.

In order to see whether or not all the elements of the set FT have been checked, the value of i and the value of n(FT) representing the number of elements of the set FT may be compared with each other (S924). In case the value of i is smaller than the value of n(FT), 1 may be added to i (S926) to perform the above-described processes for a next element in the set FT, and in case the value of i is equal to or greater than the value of n(FT), the allocation process may end since all the elements have been checked.

### Embodiment 3

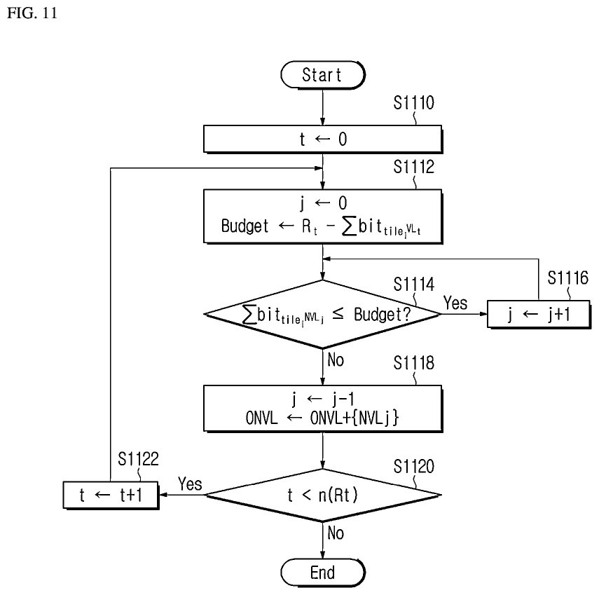

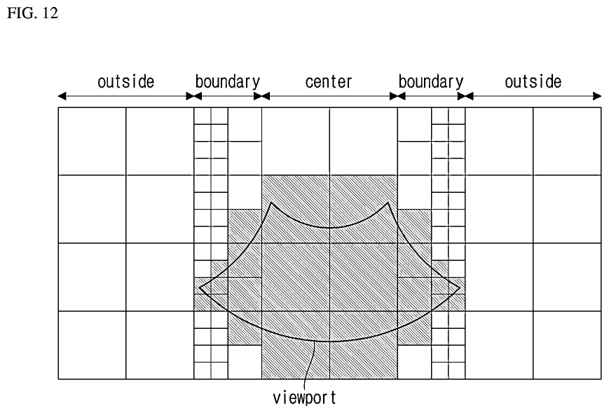

Embodiment 3 relates to a method for adaptively determining a bit rate per tile. An image encoding method according to Embodiment 3 is shown in FIG. 11, and an example of allocating a bit rate according to Embodiment 3 is shown in FIG. 12.

In FIG. 11, Rₜ represents a predefined target bit rate, VLₜ represents a quality level inside a user viewport (inner region and boundary region), which can be expressed by a quantization parameter and the like, and NVLⱼ represents a quality level outside the user viewport (outer region). bitₜᵢₗₑᵢ represents a bit rate of a tile bitstream tileᵢ, and tileᵢ^{VL} represents an i-th tile bitstream where a value of Σbitₜᵢₗₑ_{ᵢ}_{^{VL}} satisfies a bit rate VL. n(Rₜ) represents the number of elements included in a set Rₜ, and ONVL represents quality outside the user viewport.

The value of t is initialized to 0 (S1110), the value of j is initialized to 0, and a difference value between Σbitₜᵢₗₑ_{ᵢ}_{^{VL}}, which is a sum of bit rates of tiles inside the user viewport satisfying a quality level VLₜ, and the target bit rate Rₜ is put into a variable Budget (S1112).

$$\sum {bit}_{{tile}_{i}^{{NVL}_{j} ,}}$$

which is a sum of bit rates of tiles outside the user viewport (candidate bit rates for encoding the outer region), and a target bit rate Budget may be compared with each other (S1114). In case

$$\sum {bit}_{{tile}_{i}^{{NVL}_{j}}}$$

is equal to or smaller than the Budget, the bit rate of tiles outside the user viewport may be increased by adding 1 to the variable j (S1116). In case

$$\sum {bit}_{{tile}_{i}^{{NVL}_{j}}}$$

exceeds the Budget, NVLⱼ, which is a bit rate outside the viewport obtained by subtracting 1 from the variable j (that is, a previously searched bit rate), may be added to ONVL (S1118).

In order to see whether or not all the elements of the set Rₜ have been checked, the value of i and the value of n(Rₜ) representing the number of elements of the set Rₜ may be compared with each other (S1120). In case the value of i is smaller than the value of n(Rₜ), 1 may be added to i (S1126) to perform the above-described processes for a next element in the set Rₜ, and in case the value of i is equal to or greater than the value of n(Rₜ), the allocation process may end since all the elements have been checked.

### Test Result

A test is performed for the adaptive tile size allocation and bit rate allocation that are described through the embodiments of the present disclosure. As a result, as shown in Table 1 and Table 2, in comparison with the related art, the embodiments of the present disclosure show improved performance in BD-rate reduction and decoding time reduction.

TABLE 1

| Mode | Sequence | 4 × 8 | 8 × 16 | 16 × 32 | Proposed |
|---|---|---|---|---|---|
| Option1 | KiteFlite | −29.21% | −30.70% | −29.95% | −31.21% |
| | Harbor | −28.88% | −31.74% | −29.32% | −30.76% |
| | Trolley | −26.49% | −27.88% | −27.63% | −28.84% |
| | Gaslamp | −29.75% | −30.05% | −25.15% | −30.35% |
| Option2 | KiteFlite | −30.87% | −31.20% | −29.70% | −31.94% |
| | Harbor | −31.27% | −32.70% | −29.89% | −32.29% |
| | Trolley | −28.93% | −29.43% | −28.95% | −29.54% |
| | Gaslamp | −30.11% | −29.70% | −27.01% | −30.79% |
| Average | KiteFlite | −30.04% | −30.95% | −29.82% | −31.57% |
| | Harbor | −30.07% | −32.22% | −29.60% | −31.53% |
| | Trolley | −27.71% | −28.65% | −28.29% | −29.19% |
| | Gaslamp | −29.93% | −29.88% | −26.08% | −30.57% |
| — | Average | −29.44% | −30.42% | −28.45% | −30.72% |

TABLE 2

| Mode | Sequence | 4 × 8 | 8 × 16 | 16 × 32 | Proposed |
|---|---|---|---|---|---|
| Option1 | KiteFlite | 122.86% | 126.57% | 149.11% | 100.81% |
| | Harbor | 123.48% | 123.16% | 150.12% | 103.71% |
| | Trolley | 129.78% | 136.87% | 152.70% | 105.19% |
| | Gaslamp | 129.04% | 141.66% | 160.04% | 101.49% |
| Option2 | KiteFlite | 122.11% | 122.31% | 138.84% | 98.83% |
| | Harbor | 121.65% | 121.40% | 138.58% | 102.87% |
| | Trolley | 126.62% | 122.50% | 145.20% | 103.58% |
| | Gaslamp | 129.56% | 134.97% | 145.82% | 105.78% |
| Average | KiteFlite | 122.48% | 124.44% | 143.98% | 99.82% |
| | Harbor | 122.57% | 122.18% | 144.35% | 103.29% |
| | Trolley | 128.20% | 129.69% | 148.95% | 104.38% |
| | Gaslamp | 129.30% | 138.31% | 152.93% | 103.64% |
| — | Average | 125.64% | 128.68% | 147.55% | 102.78% |

In the test of Table 1 and Table 2, for a 8K image, 4×8 partitioning is set by a large-sized tile, 8×16 partitioning is set by a medium-sized tile, and 16×32 partitioning is set by a small-sized tile.

Table 1 shows a test result for BD-rate. As shown in Table 1, the method according to the present disclosure shows average 30.72% BD-rate reduction as compared with the related art that is performed irrespective of user viewport.

Table 2 shows a test result for decoding time. As shown in Table 2, the method according to the present disclosure records only average 2.78% decoding time overhead as compared with the related art that is performed irrespective of user viewport, thereby showing improved reduction.

In the above-described embodiments, the methods are described based on the flowcharts with a series of steps or units, but the present disclosure is not limited to the order of the steps, and rather, some steps may be performed simultaneously or in different order with other steps.

In addition, it should be appreciated by one of ordinary skill in the art that the steps in the flowcharts do not exclude each other and that other steps may be added to the flowcharts or one or more steps may be deleted from the flowcharts without influencing the scope of the present disclosure.

The above-described embodiments include various aspects of examples. All possible combinations for various aspects may not be described, but those skilled in the art will be able to recognize different combinations. Accordingly, the present disclosure may include all replacements, modifications, and changes within the scope of the claims.

The above-described embodiments according to the present invention may be implemented in a form of program instructions, which are executable by various computer components, and recorded in a computer-readable recording medium. A computer-readable recording medium may include stand-alone or a combination of program instructions, data files, data structures, etc. The program instructions recorded in the computer-readable recording medium may be specially designed and constructed for the present disclosure, or well-known to a person of ordinary skilled in computer software technology field. Examples of the computer-readable recording medium include magnetic recording media such as hard disks, floppy disks, and magnetic tapes, optical data storage media such as CD-ROMs or DVD, magneto-optimum media such as floptical disks; and hardware devices, such as read-only memory (ROM), random-access memory (RAM), flash memory, etc., which are particularly structured to store and implement the program instruction. Examples of the program instructions include not only a mechanical language code formatted by a compiler but also a high level language code that may be implemented by a computer using an interpreter. The hardware devices may be configured to be operated by one or more software modules or vice versa to conduct the processes according to the present disclosure.

In the above-described embodiments, the methods are described based on the flowcharts with a series of steps or units, but the present disclosure is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or one or more steps may be deleted from the flowcharts without influencing the scope of the present disclosure.

The above-described embodiments include various aspects of examples. All possible combinations for various aspects may not be described, but those skilled in the art will be able to recognize different combinations. Accordingly, the present disclosure may include all replacements, modifications, and changes within the scope of the claims.

The above-described embodiments according to the present invention may be implemented in a form of program instructions, which are executable by various computer components, and recorded in a computer-readable recording medium. The computer-readable recording medium may include stand-alone or a combination of program instructions, data files, data structures, etc. The program instructions recorded in the computer-readable recording medium may be specially designed and constructed for the present disclosure, or well-known to a person of ordinary skilled in computer software technology field. Examples of the computer-readable recording medium include magnetic recording media such as hard disks, floppy disks, and magnetic tapes, optical data storage media such as CD-ROMs or DVD, magneto-optimum media such as floptical disks; and hardware devices, such as read-only memory (ROM), random-access memory (RAM), flash memory, etc., which are particularly structured to store and implement the program instruction. Examples of the program instructions include not only a mechanical language code formatted by a compiler but also a high level language code that may be implemented by a computer using an interpreter. The hardware devices may be configured to be operated by one or more software modules or vice versa to conduct the processes according to the present disclosure.

Although the present disclosure has been described in terms of specific items such as detailed elements as well as the limited embodiments and the drawings, they are only provided to help more general understanding of the present disclosure, and the present disclosure is not limited to the above embodiments. It will be appreciated by those skilled in the art to which the present disclosure pertains that various modifications and changes may be made from the above description.

Therefore, the spirit of the present disclosure shall not be limited to the above-described embodiments, and the entire scope of the appended claims and their equivalents will fall within the scope and spirit of the present disclosure.

What is claimed is:

1. An image encoding method performed by an image encoding apparatus, the image encoding method comprising:
encoding an image in sub-regions with different sizes and generating one or more bitstreams for the sub-regions;
obtaining a user viewport for the image;
allocating sub-regions corresponding to the user viewport among the sub-regions to the image, wherein the image includes an inner region located inside the user viewport, a boundary region adjacent to a boundary of the user viewport, and an outer region located outside the user viewport; and
generating at least one bitstream corresponding to the allocated sub-regions from bitstreams for the sub-regions,
wherein a sub-region with a relatively large size is allocated within the inner region, and
wherein a sub-region with a relatively small size is allocated within the boundary region.

2. The image encoding method of claim 1, wherein the allocating comprises:
comparing a number of sub-regions with a third size included in a sub-region with a first size and a predefined threshold value; and
allocating the sub-region with the first size, when the number of sub-regions with the third size included in the sub-region with the first size is equal to or greater than the threshold value.

3. The image encoding method of claim 2, wherein the allocating comprises:
comparing the number of sub-regions with the third size included in a sub-region with a second size and the threshold value, when the number of sub-regions with the third size included in the sub-region with the first size is smaller than the threshold value; and
allocating the sub-region with the second size, when the number of sub-regions with the third size included in the sub-region with the second size is equal to or greater than the threshold value, and
wherein the second size is smaller than the first size.

4. The image encoding method of claim 3, wherein the sub-region with the third size is allocated, when the number of sub-regions with the third size included in the sub-region with the second size is smaller than the threshold value.

5. The image encoding method of claim 1, wherein the sub-region with the relatively large size is allocated within the outer region.

6. The image encoding method of claim 5, wherein the allocating comprises:
determining whether or not a sub-region with a third size included in a sub-region with a first size is included in the outer region; and
allocating the sub-region with the first size, when the sub-region with the third size included in the sub-region with the first size is included in the outer region.

7. The image encoding method of claim 6, wherein the allocating comprises:
determining whether or not the sub-region with the third size included in a sub-region with a second size is included in the outer region, when the sub-region with the third size included in the sub-region with the first size is not included in the outer region; and
allocating the sub-region with the second size, when the sub-region with the third size included in the sub-region with the second size is included in the outer region, and
wherein the second size is smaller than the first size.

8. The image encoding method of claim 7, wherein the sub-region with the third size is allocated, when the sub-region with the third size included in the sub-region with the second size is not included in the outer region.

9. The image encoding method of claim 1, wherein, among the sub-regions, sub-regions belonging to a same row have a same size.

10. The image encoding method of claim 1, wherein the inner region and the boundary region are encoded with a relatively high bit rate, and the outer region is encoded with a relatively low bit rate.

11. The image encoding method of claim 10, wherein the generating comprises:
subtracting a bit rate for encoding the inner region and the boundary region from a predefined target bit rate; and
determining a bit rate for encoding the outer region by comparing a candidate bit rate for encoding the outer region and a result of the subtracting.

12. An image encoding apparatus comprising:
a memory; and
at least one processor,
wherein the at least one processor is configured to:
encode an image in sub-regions with different sizes and generate one or more bitstreams for the sub-regions,
obtain a user viewport for the image,
allocate sub-regions corresponding to the user viewport among the sub-regions to the image, wherein the image includes an inner region located inside the user viewport, a boundary region adjacent to a boundary of the user viewport, and an outer region located outside the user viewport, and
generate at least one bitstream corresponding to the allocated sub-regions from bitstreams for the sub-regions,
wherein a sub-region with a relatively large size is allocated within the inner region, and
wherein a sub-region with a relatively small size is allocated within the boundary region.

13. A method for transmitting a bitstream generated by an image encoding method, the image encoding method comprising:
encoding an image in sub-regions with different sizes and generating one or more bitstreams for the sub-regions;
obtaining a user viewport for the image;
allocating sub-regions corresponding to the user viewport among the sub-regions to the image, wherein the image includes an inner region located inside the user viewport, a boundary region adjacent to a boundary of the user viewport, and an outer region located outside the user viewport; and
generating at least one bitstream corresponding to the allocated sub-regions from bitstreams for the sub-regions,
wherein a sub-region with a relatively large size is allocated within the inner region, and
wherein a sub-region with a relatively small size is allocated within the boundary region.
